(19) United States
(12) Patent Application Publication
(10) Pub. No.: US 2009/0327549 A1
(43) Pub. Date: Dec. 31, 2009

(54) MONITORING UNIT FOR MONITORING OR CONTROLLING USER ACCESS TO A DATA BUS AND USER HAVING SUCH A MONITORING UNIT

(76) Inventor: Thomas Fuehrer, Gerlingen (DE)

Correspondence Address: KENYON & KENYON LLP, ONE BROADWAY, NEW YORK, NY, 10004, US

(21) Appl. No.: 12/158,866

(22) PCT Filed: Dec. 12, 2006
(86) PCT No.: PCT/EP2006/069617

§ 371 Date: Oct. 23, 2008

(30) Foreign Application Priority Data
Dec. 22, 2005 (DE) 10 2005 061 403.5

(51) Int. Cl. G06F 13/00

(52) U.S. Cl. 710/107

(57) ABSTRACT

The present invention relates to a local monitoring unit, which is locally assigned to a bus controller of a user of a communication system, a central monitoring unit of a communication system for monitoring and/or controlling the access of multiple users to a data bus. An important feature of the provided monitoring concept is that the monitoring unit has a time basis of its own that is independent of a local time basis of a communication controller of the users and that is synchronized with a global time basis of the communication system. This separate local time basis is utilized in the monitoring unit to monitor and/or control the access authorization of the communication controller or of a bus driver to the data bus. In this way, sending conflicts of the users, in particular due to permanent disturbances in one or more users, may be reliably detected and prevented.

### FIELD OF THE INVENTION

The present invention relates to a monitoring unit that is assigned locally to a bus controller of a user of a communication system, for monitoring and controlling access to a data bus according to a particular protocol. The bus controller accesses the data bus via a bus driver, and the monitoring unit monitors and controls the access authorization of the bus driver in accordance with the protocol specification.

The present invention also relates to a user of a communication system that encompasses a data bus. The user has a bus controller and a bus driver, the bus controller being connected to the data bus via the bus driver. Furthermore, the user has a monitoring unit assigned to the bus controller, for monitoring and controlling the authorization of the bus driver to access the data bus in accordance with a particular protocol specification.

Finally, the present invention also relates to a central monitoring unit of a communication system for monitoring and controlling the access of multiple users of the communication system to a data bus of the communication system. Each user has a bus controller and a bus driver, the bus controller being connected to the data bus via the bus driver. The monitoring unit monitors and controls the access authorization of the bus drivers of multiple users of the communication system to the data bus according to a particular protocol specification.

### BACKGROUND INFORMATION

The networking of control devices, sensor systems and actuator systems with the aid of a communication system or data transmission system and a communication link, e.g., in the form of a bus system or a data bus, has increased dramatically in recent years in modern motor vehicles, but also in other sectors, for example, in machine construction, especially in the field of machine tools, and in automation. In this context, synergistic effects may be achieved by distributing functions to a plurality of users, e.g., control devices, of the communication system. These are called distributed systems.

Increasingly, the communication between various users of such a communication system is taking place via a bus system. The communications traffic on the bus system, access and reception mechanisms, as well as error handling are governed by a protocol. Known protocols include, for example, CAN (Controller Area Network), TTCAN (Time Triggered CAN), TTP/C (Time Triggered Protocol Class C) and the FlexRay protocol, the FlexRay protocol specification v2.1 currently forming its basis. FlexRay is a rapid, deterministic and error-tolerant bus system, particularly for use in motor vehicles. The FlexRay protocol operates according to the principle of Time Division Multiple Access (TDMA), the users or the messages to be transmitted being assigned fixed time slots in which they have exclusive access to the communication link. The time slots repeat in a fixed cycle, so that the instant at which a message is transmitted via the bus can be predicted exactly, and the bus access takes place deterministically.

To optimally utilize the bandwidth for the transmission of messages on the bus system, FlexRay subdivides the communication cycle into a static and a dynamic part, that is, into a static and a dynamic segment. The fixed time slots are in the static part at the beginning of the bus cycle. In the dynamic part, the time slots are preset dynamically. Therein, the exclusive bus access is in each case only permitted for a brief time, for the duration of at least one so-called minislot. The time slot is lengthened to the time necessary for the access only if a bus access takes place within a minislot. Consequently, bandwidth is thus only used up if it is also actually needed. FlexRay communicates via one or two physically separate lines at a data rate of maximally 10 Mbit/sec in each case. Of course, it is also possible to operate FlexRay at lower data rates. The two channels correspond to the physical layer, in particular of the so-called OSI (open system architecture) layer model. They are used chiefly for the redundant and therefore error-tolerant transmission of messages, but may also transmit different messages, which means the data rate could then double. It is also conceivable that the signal transmitted via the connecting lines results as a differential signal from the difference of signals transmitted via the two lines. The physical layer is developed in such a way that it permits an electrical, but also optical transmission of the signal or signals via the line(s) or a transmission in another way, for example via radio.

To implement synchronous functions and to optimize the bandwidth by small intervals between two messages, the users in the communication network need a common time basis, the so-called global time. To synchronize local clocks of the users, synchronization messages are transmitted in the static part of the cycle, the local clock time (local time basis) of a user being corrected with the aid of a special algorithm corresponding to the FlexRay specification in such a way that all local clocks run in synchronization with a global clock (global time basis).

For the different known communication systems, there are a number of options for preventing or resolving access conflicts. In CAN, for example, the so-called bit-by-bit arbitration is used. This is extremely robust. In principle, however, the maximum transmission speed is limited by runtime phenomena. For time-controlled communication systems, the access problem is resolved by approach and configuration; the conflicts are already prevented offline. A prerequisite for this is, however, a common understanding of the time that is valid throughout the network (in FlexRay: global time basis). In these systems, however, there usually is not an option for handling the access conflicts in the case of an error since the access itself cannot be prevented. For this reason, in different communication systems, for example, TTP/C or FlexRay, the introduction of a so-called bus guardian (BG) as an additional monitoring unit is known, which permits the physical access to the data bus only in the periods of time that are configured in advance. Thus, the access conflict is also resolvable or preventable in the case of an error.

In TTCAN, a combination of CAN and time-controlled bus access, the conflict is resolved via bit-by-bit arbitration. In this context, however, a situation may arise in which the (temporally) correct message content is not provided. The use of a bus guardian for messages in the static window may therefore be useful in TTCAN, for example, for safety-relevant systems, like X-by-Wire systems.

In current concepts, the local bus guardian is supplied by the clock pulse of the bus controller, and its cycle information is used for the monitoring function. In the current FlexRay protocol specification v2.1, a concept is described that is restricted with regard to the temporal monitoring of the communication protocol or the communication controller. In the provided concept, a macrotick (MT) of the local FlexRay communication controller clocks its local bus guardian. The time slot having sending activity is indicated by the communication controller additionally by an ARM signal. The timing (the temporal activities) of the FlexRay communication controller to be monitored is monitored roughly by an RC oscillator (deviations are detected only starting at approximately 30%) only, or also at a higher resolution by an additional quartz oscillator.

In principle, however, the problem remains that the macrotick supply and the ARM signals transmit smaller clock drifts of the local communication controller to the bus guardian. This means that if the clock correction (for the synchronization of the local time basis with the global time basis) of the FlexRay communication controller according to the protocol specification v2.1 operates defectively or the setting of the adjusting register for clock correction is erroneous and the errors undiscovered, the local communication controller drifts relative to the remaining communication network. The time slots for sending messages will shift into the time slots of the other users in the network without the local bus guardian being able to detect this situation and introduce appropriate countermeasures. This problem case arises in particular in FlexRay and TTCAN.

Another problem case relates to the offset correction of the local times of the users so that the local times run synchronously with the global time of the communication system. There is an offset correction, for example, in TTCAN, TTP/C, and FlexRay, in FlexRay the offset correction phase taking place during the so-called Network-Idle-Time (NIT) of the local communication controller at the end of a communication cycle. The correction of the offset at the end of a communication cycle or a double cycle decreases or increases the local cycle within predefined specified limits.

Due to the correction, the next communication cycle begins a few so-called microticks (μT) earlier or later. The local bus guardian must allow this offset correction. The time monitoring must accept this. However, in the bus guardian no knowledge exists regarding the effects that the offset correction has on the next communication cycle. In this case too, the sending time slots of the different users may overlap. The probability of an overlap increases with the number of cycles.

The bus guardian concept according to the FlexRay protocol specification v2.1 is based on the assumption that there is only a low probability that the described error cases occur due to permanent disturbances, or these disturbances or errors may be detected by additional measures in the user host or through supplementary functionalities.

A permanent disturbance of the communication controller exists in both of the problem cases mentioned. In contrast, spontaneous errors do not lead to this situation since the communication protocol itself provides appropriate corrective measures or error-handling measures to detect, correct, and remove spontaneous errors.

### SUMMARY

According to example embodiments of the present invention, permanent disturbances in the communication may additionally be detected and possibly corrected or removed.

Starting from the local monitoring unit of the type mentioned at the outset, it is provided that the monitoring unit:
is connected to the data bus via the bus driver,
has a decoding unit for decoding messages received through the data bus and the bus driver,
has an oscillator connection,
has a clock synchronization unit for synchronizing a local clock of the monitoring unit,
has a bus access control unit for establishing a temporal correlation between received messages and a communication cycle according to protocol specification,
has sending information of the local bus controller provided in accordance with the communication schedule, and
has a comparator unit for ascertaining deviations between the provided sending information and the actual bus access of the bus controller or the bus driver on the basis of the synchronized local clock of the monitoring unit.

Because the local monitoring unit is connected to the data bus via the bus driver, messages transmitted via the data bus may be received not only by the bus controller (in FlexRay: communication controller), but rather also by the monitoring unit. The received messages from the monitoring unit may be decoded by the decoding unit in accordance with the protocol specification used in the communication system. Through these two measures, reception and decoding of messages, it is possible for the local monitoring unit to receive and understand synchronization messages sent via the data bus (so-called sync frames). Via the oscillator connection, the monitoring unit is able to obtain a clock pulse of its own that is completely independent of the local bus controller. The clock synchronization unit is a logic circuit that enables the local monitoring unit to establish a globally synchronized time basis in accordance with the protocol specification being used in the communication system. In the process, the received, decoded, and evaluated synchronization messages are recorded and supplied to an internal correction, for example, a rate and offset correction, of the local monitoring unit.

The bus access control unit is a logic circuit that is able to establish the temporal correlation between the reception of the synchronization messages and the communication cycles in accordance with the protocol specification used. The bus access control unit is also referred to as media access control (MAC). The comparator unit of the local monitoring unit ascertains differences between a clock signal of the local monitoring unit and the provided sending information of the bus controller that was derived from it and the actual bus access of the bus controller. If such differences are detected, preferably a so-called fail-silent response is triggered in the local monitoring unit, and thus the local bus controller is prevented from sending.

The local monitoring unit may also be designated as bus guardian (BG). An aspect of the monitoring unit is the complete temporal independence from the local bus controller and the local time basis of the bus controller, and the generation of a local time basis of its own that is synchronized with the global time. By checking the consistency of the local time basis of the monitoring unit with the local time basis of the assigned bus controller, access errors, in particular due to permanent disturbances, may be safely and reliably detected, even when the number of cycles increases. The error cases described at the outset, in particular due to permanent disturbances, are secured by the present invention, and a fail-silent response of the entire user may be achieved.

Example embodiments of the present invention eliminate the conceptual weak points of the known bus guardian concepts that are used in the hitherto known communication systems. In this instance, a cost-optimized implementation of the bus guardian concept is possible since only the logic components and functionalities that are necessary for the reception, decoding, and evaluation of the synchronization messages are provided in the local monitoring unit. Without exception, the components used are known components that are used in other places in communication systems and that now are integrated into the monitoring unit in a particularly advantageous way. The components additionally integrated in the local monitoring unit may thus easily be used in other areas of the communication system as well, for example, in the bus controller, so that high quantities of the components result, which leads to a reliability in manufacture and to lower unit prices. Furthermore, the concept according to the present invention may be easily integrated into a so-called monitoring computer of a communication system. Such a central monitoring unit is not assigned to a single user of the communication system, but rather monitors and controls the access of multiple users of the communication system to the data bus. The concept of the monitoring computer has the advantage that a separate bus guardian is not necessary for each user, but rather that their functionalities may be integrated into a single or a few monitoring computers.

The application of the local monitoring unit is in particular suitable for a FlexRay communication system in which the communication controller communicates to the local bus guardian the beginning of a communication cycle via an ARM signal. An exemplary embodiment described herein is suitable for communication systems other than FlexRay, for example, for a TTCAN communication system, where the sending information of the local bus controller may be stored in advance in the bus guardian. The stored sending information may, for example, be utilized for generating an ARM signal. A cycle synchronization is achieved or made plausible by the reference message.

Preferred exemplary embodiments of the present invention and additional advantages of the present invention are described in more detail in the following with the aid of figures.

### BRIEF DESCRIPTION OF THE DRAWINGS

FIG. 1a a simplified topology of a communication system according to an example embodiment of the present invention;

FIG. 1b a simplified topology of a communication system according to an example embodiment of the present invention;

FIG. 2 a user, known from the related art, of a communication system having a known bus guardian concept;

FIG. 3 the curve of an enable signal by which a bus guardian controls the access authorization of a bus controller in a known user as shown in FIG. 2;

FIG. 4 a user according to an example embodiment of the present invention;

FIG. 5 the curve of a part of the communication via a data bus of the communication system as shown in FIGS. 1a and 1b.

### DETAILED DESCRIPTION

Example embodiments of the present invention are explained in the following by way of example with reference to a FlexRay communication system. Example embodiments of the present invention may also be applied in other communication systems in which other bus guardian concepts are currently already being used, or in which the bus guardian concept according to example embodiments of the present invention seems useful and/or would be advantageous.

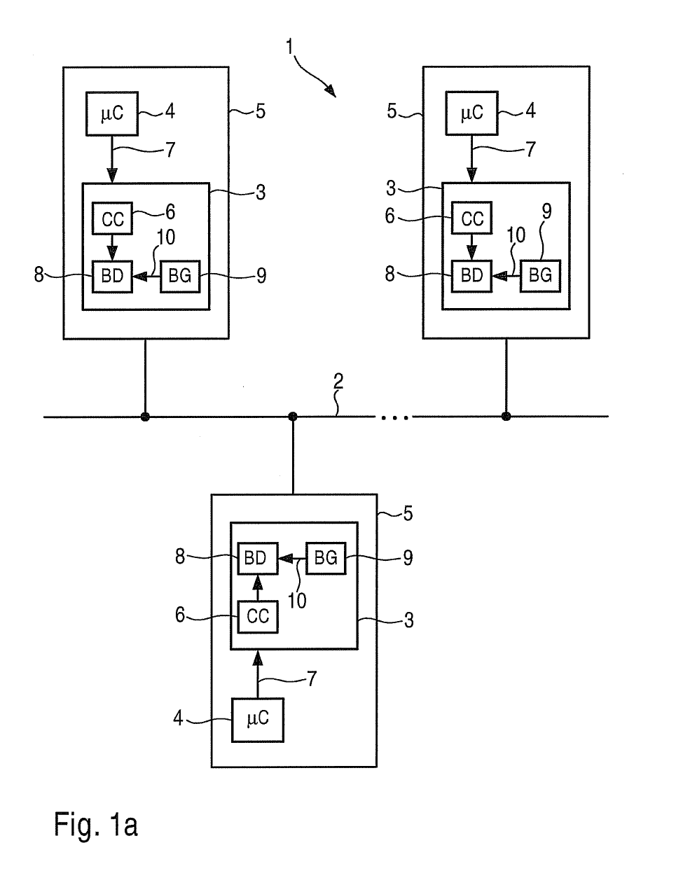

In FIG. 1a, a simplified topology of a known FlexRay communication system is designated in its entirety by the reference numeral 1. Communication system 1 includes a physical layer, which in the present case takes the form of a data bus 2 having two electrically conductive lines. Of course, the physical layer may also be implemented as optical waveguides or as radio links. Likewise, it is also conceivable to provide not two separate transmission channels but rather only one channel. Multiple FlexRay users 3, which are also called control devices or hosts, are connected to data bus 2. However, strictly speaking, the host also includes a microcontroller that is labeled with the reference symbol 4 in FIG. 1a. Thus, user 3 and microcontroller 4 form together the actual host 5.

Users 3 of the FlexRay communication system each include one FlexRay communication controller 6, which receives information 7 from microcontroller 4 to be transmitted via data bus 2 and, in accordance with the protocol specification used in communication system 1, according to the FlexRay protocol specification v2.1 in the example presented, brings it into the right data format for transmission via data bus 2. Items of information 7 in the right data format are transmitted to FlexRay bus driver 8 of user 3, which brings them into a form required for the transmission via data bus 2, likewise in accordance with the protocol specification used.

To prevent, for example, in safety-related applications of communication system 1, data bus 2 from being blocked by a defective, constantly sending user 3 (so-called babbling idiot), bus guardians 9 are provided in users 3, which monitor and control the access authorization of communication controller 6. Bus drivers 8 may apply information or data packets to data bus 2 only if they obtain an appropriate enable signal 10 from associated bus guardian 9.

FlexRay communication system 1 from FIG. 1a has a particularly simple topology. Of course, the topology of data bus 2 may also be configured as ring-shaped or star-shaped. Likewise, it is also conceivable to dispose amplifier units, for example, as a component of an active star, in data bus structure 2 for the transmission of data packets over longer distances.

FIG. 1b shows another topology of a likewise known FlexRay communication system 1. This topology differs from the topology known from FIG. 1a in particular by the fact that users 3 of communication system 1 are not each equipped with a separate bus guardian. Rather, in the specific embodiment shown in FIG. 1b, the bus guardian functionality from individual users 3 has been combined into one single monitoring computer 11. The monitoring computer 11 also has a communication controller 6 and a bus driver 8 so that the monitoring computer 11 is able to send and receive information via data bus 2. The extended bus guardian functionalities (extended bus guardian, BGX) of monitoring computer 11 are labeled with the reference symbol 12. In addition to being connected to users 3 by data bus 2, monitoring computer 11 is preferably also connected to users 3 by another communication connection (not shown), so that monitoring computer 11 is still able to trigger and, where necessary, interrupt the sending activity of users 3, even when one of users 3 constantly sends and in this manner blocks data bus 2 for any data transmission by the other users 3 and by monitoring computer 11. Monitoring computer 11 has for each of users 3 information regarding its sending activities; it monitors the sending activities of users 3, and controls them.

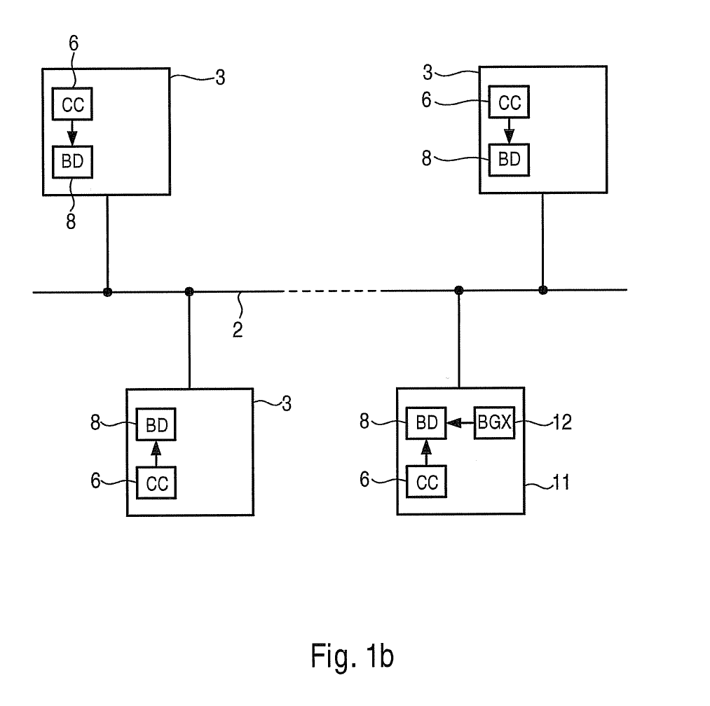

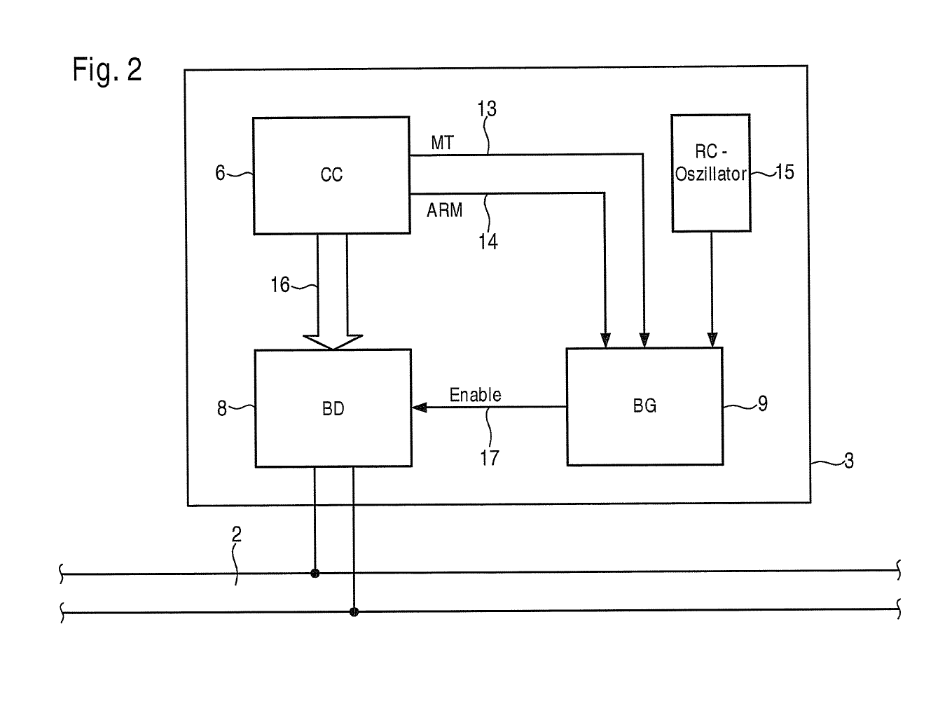

FlexRay user 3 known from the related art is shown in FIG. 2 with a known bus guardian concept. The concept described in the FlexRay protocol specification v2.1 is restricted with regard to the temporal monitoring of the communication protocol or of communication controller 6. In user 3 having the known monitoring concept, bus guardian 9 derives its time basis from the corrected macrotick (MT) signal 13, which it obtains from communication controller 6. The time slot with sending activity (time slot #2 in FIG. 3) is additionally indicated by an ARM signal 14 of communication controller 6. ARM signal 14 serves to synchronize the beginning of a communication cycle or the sending slot of the communication cycle. The time sequences (the so-called timing) of the FlexRay communication controller 6 to be monitored is monitored roughly only by an RC oscillator 15, or by an additional quartz oscillator also at a higher resolution. RC oscillator 15 permits only a rough monitoring of macrotick signal 13 so that deviations are detected as deviations only when they are above 20 to 30% of the signal.

Thus, the time basis of bus guardian 9 is not independent of the time basis of communication controller 6 but rather dependent on macrotick signal 13. Through the monitoring of this signal 13 by RC oscillator 15, a complete independence from the time basis of communication controller 6 cannot be achieved. The data to be transmitted via data bus 2, which communication controller 6 transmits to bus driver 8, are labeled with the reference symbol 16 in FIG. 2. Data 16 are applied to data bus 2 via bus driver 8. However, the activity of bus driver 8 is monitored and/or controlled by bus guardian 9 to such an extent that bus driver 8 may apply data 16 to data bus 2 only if bus guardian 9 confirms the access authorization of bus driver 8 by applying an enable signal 17 to bus driver 8.

The known monitoring concept has weaknesses in particular in the cases in which permanent disturbances exist that, due to errors or inaccuracies in communication controller 6, in a gradual shifting of the sending time slots of user 3 into the other sending time slots of the remaining users 3 of the communication cycle. Such gradual errors in timing are not able to be detected by the known concept, although they contradict the communication schedule of communication system 1. Thus, a problem exists, for example, that through macrotick supply 13 and ARM signals 14 minimal clock drifts of the local communication controller 6 may be transmitted to bus guardian 9. Thus, if the clock correction of FlexRay communication controller 6 according to protocol specification v2.1 operates defectively or the setting of adjusting registers of communication controller 6, which are utilized for clock correction, is erroneous and undiscovered, local communication controller 6, and thus also local bus guardian 9, drifts relative to the remaining communication network 1. Since communication controller 6 and bus guardian 9 drift together, bus guardian 9 is also unable to detect any deviations of the sending activity of communication controller 6 from the communication schedule. The sending slots of the communication cycle for user 3, whose communication controller 6 has errors or inaccuracies in the local time basis, will thus over time shift into the sending time slots of other users 3 in communication network 1, without local bus guardian 9 being able to detect this situation and trigger appropriate reactions.

Another problem case is the so-called offset correction phase during the so-called network idle time (NIT) of local communication controller 6 at the end of a communication cycle. The offset correction phase is used, among other things, to synchronize the local time basis of user 3 to the global time basis of communication system 1. To carry out such a correction, corrections are allowed within specified limits. The subsequent communication cycle then begins a few microticks (μT) earlier or later. Local bus guardian 9 must permit this correction. The timer monitoring must accept this. However, no bus guardian knowledge exists regarding the effects of the offset correction on the next communication cycle. In this case too, an overlap of the sending time slots may result. The probability of such an overlap increases with the number of cycles.

FIG. 3 shows the curve of enable signal 17 of known user 3, shown in FIG. 2, with the known monitoring concept. The shown user 3 is permitted to send only in the sending slot #2, so that enable signal 17 must permit, for user 3 shown, the sending of data by bus driver 8 during the entire sending slot #2. To be on the safe side, enable signal 17 switches from “disable” to “enable” a short time before the beginning of sending slot #2, and only switches back from “enable” to “disable” some time after the end of sending slot #2.

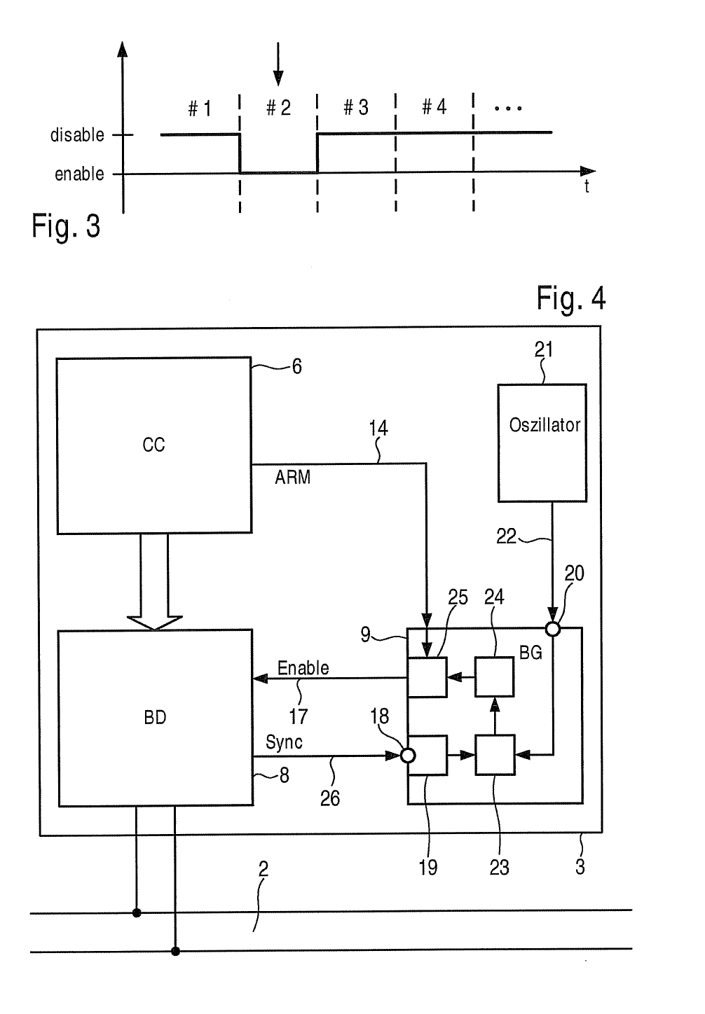

FIG. 4 shows a user 3 of a communication system 1 according to an example embodiment of the present invention, in which the novel monitoring concept is implemented. A difference to known users 3 results from this: that bus guardian 9 has a local time basis of its own that is completely independent of the time basis of communication controller 6. This local time basis of bus guardian 9 is, like the time basis of communication controllers 6 of all users 3, synchronized with the global time basis of communication system 1. An evaluation and control of the access activities of bus driver 8 to data bus 2 then takes places with the aid of the local, independent time basis of local bus guardian 9.

For the implementation of the monitoring concept, bus guardian 9 contains the following components:
A connection 18, which serves to connect bus guardian 9 to data bus 2 via bus driver 8.
A decoding unit 19 for decoding messages received via data bus 2 and bus driver 8.
An oscillator connection 20 via which a quartz oscillator 21 may be connected and may transmit a clock signal 22 to bus guardian 9.
A clock synchronization unit 23 for synchronizing the local clock of bus guardian 9 with the global time basis of communication system 1, which time basis is communicated to bus guardian 9 via synchronization messages, which are transmitted via data bus 2.
A bus access control unit 24 for establishing a temporal correlation between received messages and a communication cycle according to the FlexRay protocol specification.
Information about sending times, provided according to the communication schedule, of the local communication controller 6, which bus guardian 9 obtains in the exemplary embodiment from FIG. 4 via ARM signal 14.
A comparator unit 25 which is used to ascertain deviations between the provided sending information according to ARM signal 14 and the actual bus access on the basis of the synchronized local time basis of bus guardian 9.

Connection 18 and decoding unit 19 are required in order to be able to receive via bus driver 8 FlexRay data frames, in particular the synchronization messages (so-called sync frames), transmitted via data bus 2. Using these, clock synchronization unit 23 builds up a time basis of its own according to the rules of the FlexRay protocol specification v2.1 with the aid of clock signal 22 of oscillator 21. In bus access control unit 24, which is also called Media Access Control (MAC), the consistency with local communication controller 6 is checked on the basis of this independent local time basis. Comparator 25 represents the extended functionality of bus guardian 9 for monitoring the time information of local communication controller 6 on the basis of the independent local time basis of bus guardian 9. Thus, the error cases described at the outset, in particular those due to permanent disturbances to the time basis of communication controller 6, are secured and a fail-silent response of the entire host 5 is ensured.

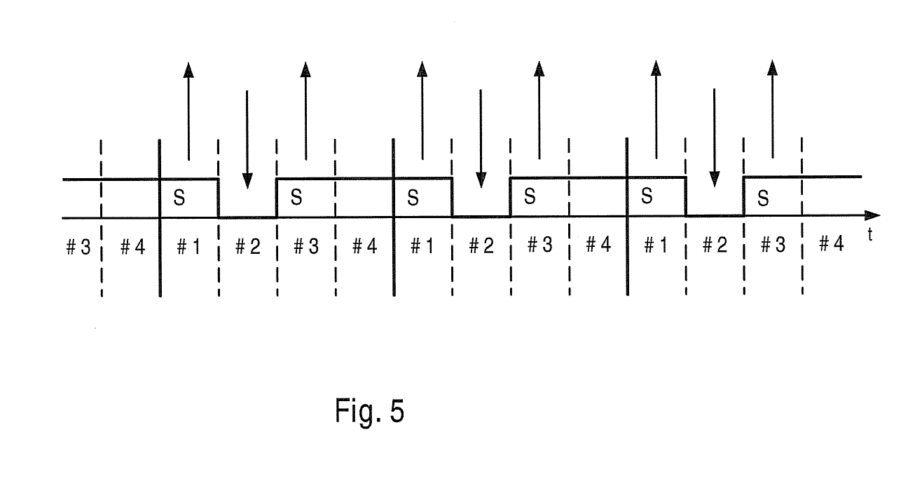

FIG. 5 shows multiple communication cycles on data bus 2 by way of example. In the example shown, each communication cycle includes four sending slots #1 to #4. User 3 from FIG. 4 is permitted to send in sending slot #2 via data bus 2. This thus means that the enable signal must be set to “enable” at least for the duration of the entire sending slot #2. In the preceding time slot #1, and in the subsequent time slot #3, synchronization messages S are transmitted via data bus 2, which are received by users 3 and utilized for synchronizing the local time bases in communication controllers 6 of users 3. In the monitoring concept according to example embodiments of the present invention, synchronization messages S are additionally also utilized for synchronizing bus guardians 9. To this end, messages S are received by bus driver 8 of a user 3 and are applied via a connection line (sync) 26 to connection 18 of bus guardian 9. There they are decoded in the way described above and utilized for synchronizing the separate local time basis of bus guardian 9, which is independent of the time basis of communication controller 6.

The present invention eliminates the conceptual weak points of known bus guardian concepts in FlexRay protocol specification v2.1, as well as in other protocol specifications. In this context, a cost-optimized implementation is possible, since bus guardian 9 is extended only by necessary logic or functionality. In bus guardian 9, it is possible to take over many components (hardware descriptions) from existing communication controllers 6 or other components of a communication system.

The monitoring concept described above with the aid of FIGS. 4 and 5 may be integrated not only into local bus guardians 9 of users 3 of communication system 1, but also could be combined into a monitoring computer 11 to form an extended bus guardian functionality 12 (BGX) (compare FIG. 1b). Thus, the bus guardian concept according to the present invention would not be implemented in each individual user 3 of communication system 1, but rather only in one or multiple monitoring computers 11, which each monitor and/or control the access authorization of bus drivers 8 of multiple users 3 of communication system 1.

1-11. (canceled)

12. A monitoring unit that is locally assigned to a bus controller of a user of a communication system, for at least one of (a) monitoring and (b) controlling access to a data bus in accordance with a particular protocol, the bus controller accessing the data bus via a bus driver and the monitoring unit monitoring and controlling access authorization of the bus driver in accordance with the protocol specification, wherein the monitoring unit:
is connected to the data bus via the bus driver;
has a decoding unit for decoding messages received via the data bus and the bus driver;
has an oscillator connection;
has a clock synchronization unit configured to synchronize a local clock of the monitoring unit;
has a bus access control unit configured to establish a temporal correlation between received messages and a communication cycle according to the protocol specification;
has sending information, provided in accordance with the communication schedule, of the local bus controller;
has a comparator unit configured to determine deviations between the sending information provided and the actual bus access on the basis of the synchronized local clock of the monitoring unit.

13. The monitoring unit according to claim 12, wherein the oscillator connection enables bit decoding.

14. The monitoring unit according to claim 12, wherein the clock synchronization unit synchronizes the local clock of the monitoring unit with a globally synchronized time basis of the communication system.

15. The monitoring unit according to claim 14, wherein the clock synchronization unit synchronizes the local clock of the monitoring unit as a function of synchronization messages received via the data bus and the bus driver.

16. The monitoring unit according to claim 12, wherein the clock synchronization unit executes at least one of (a) an offset correction and (b) a rate correction for synchronizing the local clock of the monitoring unit.

17. The monitoring unit according to claim 12, wherein the monitoring unit receives the sending information, provided in accordance with the communication schedule, of the local bus controller in the form of an appropriate signal from the bus controller.

18. The monitoring unit according to claim 12, wherein the sending information, provided in accordance with the communication schedule, of the local bus controller is stored in the monitoring unit.

19. The monitoring unit according to claim 12, wherein the monitoring unit is designed as a bus guardian of a FlexRay communication system (1).

20. A user of a communication system encompassing a data bus, the user having a bus controller and a bus driver, the bus controller being connected via the bus driver to the data bus, and the user having a monitoring unit, assigned to the bus controller, configured to at least one of (a) monitor and (b) control access authorization of the bus driver to the data bus in accordance with a particular protocol specification, wherein the monitoring unit:
is connected to the data bus via the bus driver;
has a decoding unit configured to decode messages received via the data bus and the bus driver;
has an oscillator connection;
has a clock synchronization unit configured to synchronize a local clock of the monitoring unit;
has a bus access control unit configured to establish a temporal correlation between received messages and a communication cycle according to the protocol specification;
has sending information, provided in accordance with the communication schedule, of the local bus controller; and
has a comparator unit configured to determine deviations between the sending information provided and the actual bus access on the basis of the synchronized local clock of the monitoring unit.

21. The user according to claim 20, wherein the monitoring unit is configured according to claim 12.

22. A central monitoring unit of a communication system for monitoring and controlling the access of multiple users of the communication system to a data bus of the communication system, each user having a bus controller and a bus driver, the bus controller being connected to the data bus via the bus driver, and the monitoring unit at least one of (a) monitoring and (b) controlling access authorization of the bus driver of multiple users of the communication system to the data bus in accordance with a particular protocol specification, wherein the central monitoring unit:
is connected to the data bus via the bus driver;
has a decoding unit configured to decode messages received via the data bus and the bus driver;
has an oscillator connection;
has a clock synchronization unit configured to synchronize a local clock of the monitoring unit;
has a bus access control unit configured to establish a temporal correlation between received messages and a communication cycle according to the protocol specification;
has sending information, provided in accordance with the communication schedule, of the local bus controller; and
has a comparator unit configured to determine deviations between the sending information provided and the actual bus access on the basis of the synchronized local clock of the monitoring unit.
